(19) United States
(12) Patent Application Publication
(10) Pub. No.: US 2008/0133850 A1
(43) Pub. Date: Jun. 5, 2008

(54) Computer device with function of selectively redeploying one of memory modules as hard disc

(75) Inventor: Kain Pai, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/633,425

(22) Filed: Dec. 5, 2006

(51) Int. Cl. G06F 12/00

(52) U.S. Cl. 711/154; 711/E12.001

(57) ABSTRACT

A computer device with a function of selectively redeploying one of memory modules as a hard disc is provided, including at least two memory modules, first and second channels of which are selectively deployed as system memory(s) and hard disc(s); a data-accessing control module, for selecting a part of the memory modules as the system memory or the hard disc, and for responding to a memory-accessing command to control a data-accessing process for the memory modules; a transforming module, for transforming a disc-accessing command of the data-accessing process into the memory-accessing command; and a data-transmitting bridge, for connecting the data-accessing control module and a chip set, such that the chip set recognizes the selected memory module(s) as the hard disc(s), so as to transmit data of the data-accessing process.

### BACKGROUND OF THE INVENTION

1. Field of Invention

The present invention relates to a technical means of accessing, addressing, or memory address allocation of a memory system, and more particularly to a computer device with a function of selectively redeploying one of memory modules as a hard disc.

2. Related Art

Generally speaking, the data-accessing speed of a memory is higher than that of a hard disc, and the memory does not have the problem that a read/write head of the hard disc searches for data. Therefore, if the memory can be used as the hard disk, it will be more efficient to load a system or to execute a program. Currently, products realizing the aforementioned function have been commercially available on market. Such a product mainly uses one PCI interface card, and arranges a plurality of memory slots and memory modules on the interface card. Then, one memory access chip is used to obtain the required hard disk capacity. The disadvantage of the aforementioned product lies in that a user has to install memory modules other than the main memory of the computer system, and the interface card occupies certain space and one interface card slot, which is inconvenient in use, and is inapplicable to server systems (e.g., a blade server) that emphasize on the operating speed, utilization rate of parity space, and heat dissipation.

Accordingly, it has become a problem for researchers to solve how to provide a computer device with a function of selectively redeploying one of memory modules as a hard disc, so as to improve the overall operational efficiency of the computer system.

### SUMMARY OF THE INVENTION

In view of the above problems, the present invention provides a computer device with a function of selectively redeploying one of memory modules as a hard disc. By deploying one of the memory modules as a system memory or a hard disc, and accessing data in a dual channel mode, the overall operational efficiency of the computer is improved. As additional hard disc devices are not required, the manufacturing cost of the computer system is further reduced.

The computer device with a function of selectively redeploying one of memory modules as a hard disc disclosed in the present invention comprises at least two memory modules, first and second channels of which are selectively deployed as system memory(s) and hard disc(s), wherein the memory modules perform a data-accessing process in a dual channel mode; a transforming module, for transforming a disc-accessing command of a data-accessing process into a memory-accessing command; a data-accessing control module, for selecting a part of the memory modules as the system memory or the hard disc, and for responding to the memory-accessing command to control the data-accessing process for the memory modules, wherein the data-accessing control module is connected with a basic input/output module, so as to set a part of the memory modules as the hard disc; and a data-transmitting bridge, for connecting the data-accessing control module and a chip set, such that the chip set recognizes the selected memory module(s) as the hard disc(s), so as to transmit data of the data-accessing process.

According to the computer device with a function of selectively redeploying one of memory modules as a hard disc, the user selectively sets the memory module(s) as a system memory or a hard disc, and the overall operational efficiency of the computer is improved by utilizing the feature that the memory modules have high data access speed. Moreover, as no additional hard disc is required, the manufacturing cost of the computer system is reduced.

As for features and examples of the present invention, a preferred embodiment will be illustrated in detail with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the system of an embodiment of the present invention.

### DETAILED DESCRIPTION OF THE INVENTION

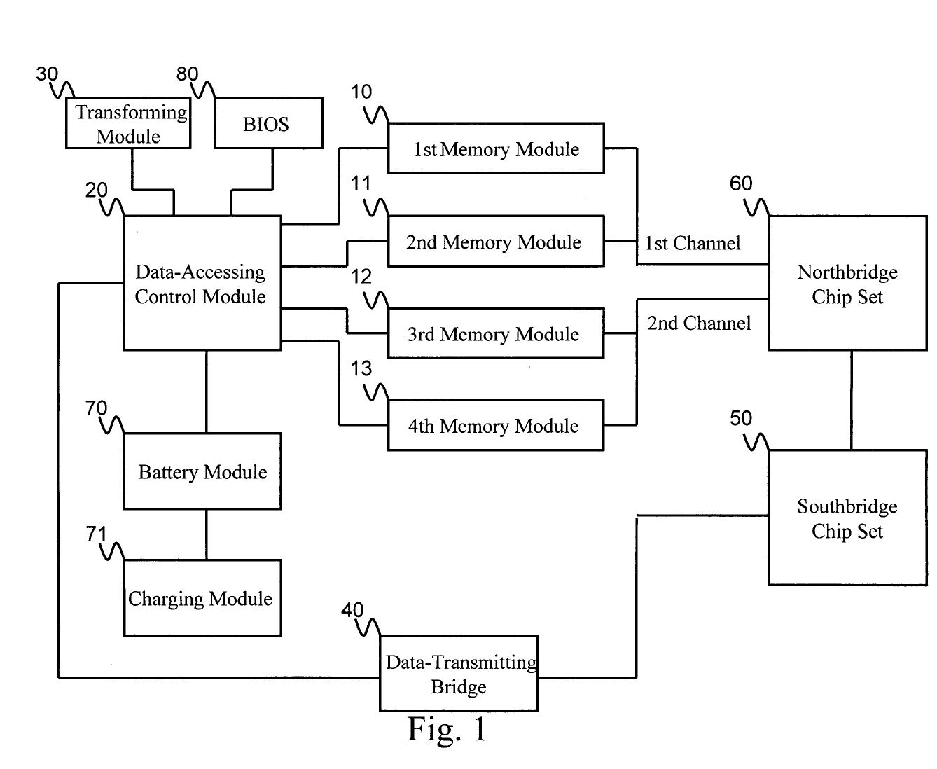

FIG. 1 is a block diagram of the system of an embodiment of the present invention. Referring to FIG. 1, the computer device with a function of selectively redeploying one of memory modules as a hard disc of the present invention includes a first memory module 10, a second memory module 11, a third memory module 12, a fourth memory module 13, a data-accessing control module 20, a transforming module 30, a data-transmitting bridge 40, a southbridge chip set 50, a northbridge chip set 60, a battery module 70, a charging module 71, and a basic input/output system (BIOS) 80.

A terminal of the first memory module 10 is connected with the data-accessing control module 20, and the other terminal is connected with the northbridge chip set 60, so as to store data. The first memory module 10, which is a volatile memory, can be selectively deployed as a system memory or a hard disc. The first memory module 10 can be a random access memory (RAM) or a double -data rate memory (DDR memory) in practice. In addition, the first memory module 10 transmits data through a first channel, and forms a dual channel transmission mode together with the third memory module 12.

A terminal of the second memory module 11 is connected with the data-accessing control module 20, and the other terminal is connected with the northbridge chip set 60, so as to store data. The second memory module 12, which is a volatile memory, can be selectively deployed as a system memory or a hard disc. The second memory module 11 can be a random access memory (RAM) or a double data rate memory (DDR memory) in practice. In addition, the second memory module 11 transmits data through the first channel, and forms a dual channel transmission mode together with the fourth memory module 12.

A terminal of the third memory module 12 is connected with the data-accessing control module 20, and the other terminal is connected with the northbridge chip set 60, so as to store data. The third memory module 12, which is a volatile memory, can be selectively deployed as a system memory or a hard disc. The third memory module 12 can be a random access memory (RAM) or a double data rate memory (DDR memory) in practice. In addition, the third memory module 12 transmits data through a second channel.

A terminal of the fourth memory module 13 is connected with the data-accessing control module 20, and the other terminal is connected with the northbridge chip set 60, so as to store data. The fourth memory module 13, which is a volatile memory, can be selectively deployed as a system memory or a hard disc. The fourth memory module 13 can be a random access memory (RAM) or a double data rate memory (DDR memory) in practice. In addition, the fourth memory module 13 transmits data through the second channel.

The data-accessing control module 20 is connected to the first memory module 10, the second memory module 11, the third memory module 12, the fourth memory module 13, the transforming module 30, the data-transmitting bridge 40, the battery module 70, and the BIOS 90 respectively, for selecting a part of the memory modules as a hard disc or a system memory, and for responding to a memory-accessing command of the transforming module 30 to control a data-accessing process for the memory modules.

The transforming module 30 is connected with the data-accessing control module 20, for transforming a disc-accessing command of the data-accessing process into the memory-accessing command. In practice, the received disc-accessing command and data format can be transformed to the memory-accessing command and data format by storing/burning a data transforming program in the transforming module. The transforming module 30 can be a non-volatile memory, e.g., a flash memory, an erasable programmable read-only memory (EPROM), or an electrically erasable programmable read-only memory (EEPROM).

The data-transmitting bridge 40 is connected with the data-accessing control module 20 and the southbridge chip set 50, such that the southbridge chip set 50 recognizes the selected memory module(s) as hard disc(s), so as to transmit data of the data-accessing process. Here, the data-transmitting bridge 40 transmits the data in a serial or parallel transmission mode.

The southbridge chip set 50 is connected with the data-transmitting bridge 40 and the northbridge chip set 60 respectively, for controlling a signal transmission process in peripheral interfaces of the computer system, for example, in an industry standard architecture (ISA), a peripheral controller interface (PCI), an integrated device electronics (IDE) interface, a low pin count (LPC) interface, a universal serial bus (USB), a system management bus (SM bus), a keyboard, and a mouse.

The northbridge chip set 60 is connected with the first memory module 10, the second memory module 11, the third memory module 12, the fourth memory module 13, and the southbridge chip set 50, for performing the data-accessing process with the memory modules that are deployed as the system memory, and controlling signal transmission processes of major modules, e.g., a CPU (not shown), an accelerated graphic port (AGP) (not shown), and a peripheral controller interface (PCI) (not shown) of the computer system.

The battery module 70 is connected with the data-accessing control module 20, for providing power required by the memory modules transformed to the hard disc for storing data. In a normal operating state, the power required by the memory modules transformed to the hard disc is supplied by a power supplier. However, in a power off state or interruption state, the power required by the memory modules transformed to the hard disc is supplied by the battery module 70.

The charging module 71 is connected with the battery module 70, for charging the battery module 70 after the computer system enters a standby state, so as to guarantee the power capacity of the battery module 70. Moreover, the charging module 71 can be designed by those skilled in the art to charge the battery module in the normal operating state, and such design also falls within the scope of the present invention.

The BIOS 80 is connected with the data-accessing control module 20, for enabling the user to set the memory modules into the system memory or the hard disc, and storing the setting. As for the embodiment disclosed in the present invention, the data-accessing process is performed in the dual channel transmission mode, so when the user sets the memory modules, two groups of memory modules are set at a time. For example, the first memory module 10 and the third memory module 12 are set to be the system memories, and the second memory module 11 and the fourth memory module 13 are set to be the hard discs.

The computer device with a function of selectively redeploying one of memory modules as a hard disc enables the user to selectively set the memory modules as the system memory(s) or the hard disc(s), and utilizing the feature that the memory modules have a high data-accessing speed to improve the overall operational efficiency. Thus, no additional hard disc is required, which reduces the manufacturing cost of the computer system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer device with a function of selectively redeploying one of memory modules as a hard disc, comprising:
at least two memory modules, a first channel and a second channel which are selectively deployed as a system memory and a hard disc respectively;
a transforming module, for transforming a disc-accessing command of a data-accessing process to a memory-accessing command;
a data-accessing control module, for selecting a part of the memory modules as the system memory or the hard disc, and for responding to the memory-accessing command to control the data-accessing process of the memory modules; and
a data-transmitting bridge, connecting the data-accessing control module and a chip set, such that the chip set recognizes the selected memory modules as the hard disc, so as to transmit data of the data-accessing process.

2. The computer device with a function of selectively redeploying one of memory modules as a hard disc as claimed in claim 1, wherein the memory modules performs the data-accessing process in a dual channel mode.

3. The computer device with a function of selectively redeploying one of memory modules as a hard disc as claimed in claim 1, further comprising a battery module for providing power required by the memory modules transformed into the hard disc for storing data.

4. The computer device with a function of selectively redeploying one of memory modules as a hard disc as claimed in claim 3, further comprising a charging module, for charging the battery module in a standby mode.

5. The computer device with a function of selectively redeploying one of memory modules as a hard disc as claimed in claim 1, wherein the data-accessing control module is connected with a basic input/output system (BIOS), so as to set a part of the memory modules as the hard disc with the BIOS.

6. The computer device with a function of selectively redeploying one of memory modules as a hard disc as claimed in claim 1, wherein the chip set is a southbridge chip set.

7. The computer device with a function of selectively redeploying one of memory modules as a hard disc as claimed in claim 1, wherein the memory modules deployed as the system memory performs the data-accessing process with a northbridge chip set.

8. The computer device with a function of selectively redeploying one of memory modules as a hard disc as claimed in claim 1, wherein the data-transmitting bridge transmits the data in a serial transmission mode.

9. The computer device with a function of selectively redeploying one of memory modules as a hard disc as claimed in claim 1, wherein the data-transmitting bridge transmits the data in a parallel transmission mode.
